(19) United States
(12) Patent Application Publication
(10) Pub. No.: US 2022/0101689 A1
(43) Pub. Date: Mar. 31, 2022

(54) COMPUTER-IMPLEMENTED SYSTEM AND METHOD OF MONITORING AND RESPONDING TO DYNAMIC GAMING EVENTS

(71) Applicant: Profit Pullout Pro LLC, Albuquerque, NM (US)

(72) Inventor: MICHAEL DEWAYNE BLUE, Albuquerque, MN (US)

(73) Assignee: Profit Pullout Pro LLC, Albuquerque, NM (US)

(21) Appl. No.: 17/033,725

(22) Filed: Sep. 26, 2020

(51) Int. Cl. G07F 17/32

(52) U.S. Cl. CPC G07F 17/3262; G07F 17/3227

(57) ABSTRACT

A system and a method of monitoring and responding to dynamic gaming events are disclosed. The system receives input game criteria from a player that is associated with a gaming event. Player initiates playing the gaming event. The system tracks an elapsed game time, a net money value and importance levels that correspond to player-selected criteria. The system further calculates a real-time recommendation value based on the inputs that are being received as well as inputs that are being tracked. The system responds with a recommendation or alert to the user when the recommendation value equals or exceeds a calculated threshold. This threshold can be adjusted and refined over time based on players' preference (such as their risk acceptance level). Once the threshold is reached, the system responds with an indication to the player to terminate the gaming event and is displayed to the user through an electronic device.

### FIELD OF THE DISCLOSURE

The present invention generally relates to gaming events. More specifically, the present invention relates to a computer-implemented system and a method of monitoring and responding to dynamic gaming events. The system responds to a user or player by recommending or alerting the user to terminate the gaming session or a gaming event in an online or land-based or casino game play.

### BACKGROUND OF THE DISCLOSURE

It is known that people of all legal ages enjoy playing games online or land-based game play that involves wagers. Generally, people play games either in an online environment or by using a wager game machines, such as slot machines, video poker machines and the like. Gaming events may include wager games where people aged 18 and above may bet virtual coins, points, credits or other currency (virtual or real currency). A wager game may be played by a single player or by multiple players who make a wager and collects or loses coins, or credits and the like, based upon the outcome of the game played. Generally, the popularity of the gaming event depends on the perceived likelihood of winning coins, credits or money at the machine/game as well as the entertainment value of the game relative to other available gaming options.

Although wager games provide a significant source of entertainment for participants/gamers, players generally lack control in spending virtual coins, points, credits or currency wagered during the gaming event. Particularly, if a player loses continuous rounds or levels, he/she may tend to increase the wager and may end up losing all of virtual coins, points, credits or currency. If the gaming event involves currency, then the user/player may end up losing his/her savings. This may lead to significantly negative consequences and it also reduces his/her interest or user experience in participating in gaming events in future.

Therefore, there is a need in the art to provide a system allows gamers or players to minimize the variance of losses while experiencing and enjoying gaming events. The system responds based on a players' perspective and provides an ability to personalize their experience during the dynamic gaming event.

### BRIEF SUMMARY OF THE DISCLOSURE

It is an object of the present invention to provide a system for monitoring and responding to a dynamic gaming event that avoids the drawback of known methods.

It is another object of the present invention to provide a system and a method of monitoring and responding to a dynamic gaming event by recommending a player to terminate the gaming event.

It is another object of the present invention to provide a system, a method and a non-transitory machine-readable storage medium for monitoring and responding to a dynamic gaming event by recommending a player to terminate the gaming event. The system receives real-time game criteria from a user or player corresponding to user's perspective of continuing or terminating a gaming event. The user-provided game criteria includes one of an “observed game experience”, a “game stake experience”, a “post-game element” and an “in-game user state”.

The “observed game experience” indicates player's observation of an ongoing promotion or bonus in the gaming event that benefits the player during the gaming event. The “game stake experience” indicates player's stake in the gaming event or funds that are currently in play and are at risk of being lost. The “post-game element” indicates players' future near-term obligations that influence user's play and time that's available for the gaming event. The “in-game user state” indicates players' state of mind influencing user's play during the gaming event.

The system further monitors elapsed time during gameplay. Additionally, weights or importance levels that correspond to user-selected game criteria are received by the system. The user initiates playing the gaming event. The system calculates a recommendation value based on the selected game criteria, the elapsed time, and the corresponding importance levels. The system responds by generating a recommendation or alert when the recommendation value equals or exceeds a resulting threshold value. The recommendation comprises an indication to the user to terminate the gaming event or gaming session. The system transmits the recommendation to a user's device to display the recommendation to the user.

In one embodiment of present invention, the system minimizes the variance of losses for the user while enjoying gaming events. Since the user defines input importance level criteria for the observed game experience, the game stakes, any post-game items, and user's in-game state, he/she has full control on how the system should respond or recommend. This avoids a system that makes arbitrary decisions or recommendations based on non-user-specific criteria. The alert or recommendation helps inform the user to end or terminate the gaming event while he/she may be losing wagers. This lowers the risk that the player losses all of his/her coins or credits required to participate in the gaming event. This may allow the user to play the game longer and thus have a better experience.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, like features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an environment in which a system for monitoring and responding to a dynamic gaming event is implemented, in accordance with one embodiment of present invention;

FIGS. 2 through 4 illustrate block diagrams of the system encompassing hardware and firmware/software components, a user device and a gaming machine, respectively, in accordance with one embodiment of present invention;

FIG. 5 illustrates a representative user interface for inputting criteria & receiving a recommendation from the system, in accordance with one embodiment of present invention;

FIG. 6 illustrates a feature of the gaming machine displaying the recommendation received from the system; and

FIG. 7 illustrates a method implemented by the system, in accordance with one embodiment of present invention.

### DETAILED DESCRIPTION OF THE EMBODIMENTS

The detailed description set forth below in connection with the appended drawings is intended as a description of exemplary embodiments in which the presently disclosed subject matter can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification or claims to be ascribed an uncommon or special meaning unless explicitly set forth as such. Further, the present subject matter encompasses present and future known equivalents to the known components referred to herein by way of illustration.

Although the present disclosure provides a description of a system and a method of monitoring and recommending user to terminate a gaming event, it is to be further understood that numerous changes may arise in the details of the embodiments of the system for monitoring and recommending user to terminate a gaming event. It is contemplated that all such changes and additional embodiments are within the spirit and true scope of this disclosure.

The present invention describes a system and a method of monitoring and recommending user to terminate a gaming event. The system receives game criteria selected from a user corresponding to user's perspective of continuing or terminating a gaming event. The system further receives user weights or importance levels, and tracks elapsed time. User initiates playing the gaming event. The system tracks the elapsed time and calculates a recommendation value based on the game criteria selected, and the associated importance levels. The system responds with a recommendation or alert when recommendation value equals or exceeds the threshold value. The response from the system comprises an indication to the user to terminate the gaming event. Alternatively, the response includes an alert to the user to continue or stop playing the game. The system transmits the recommendation to a user device to display the response to the user.

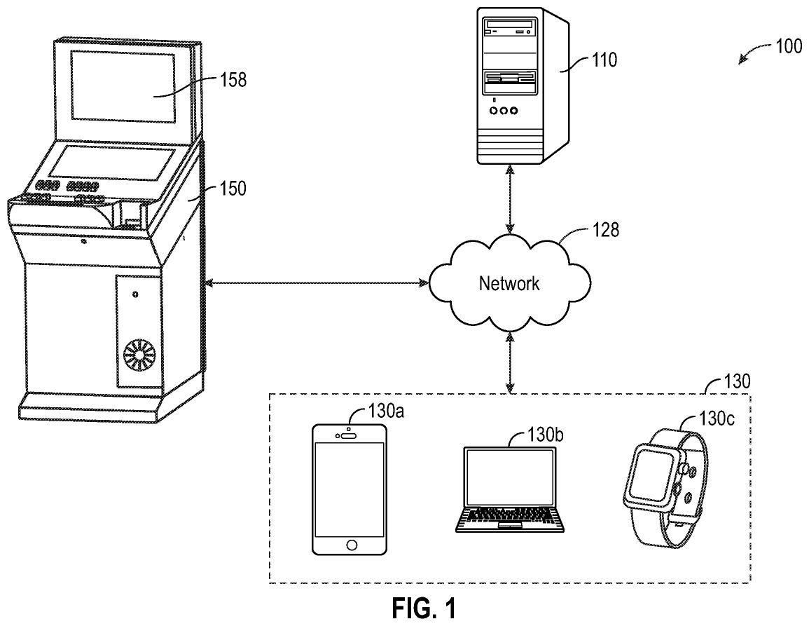

Various features and embodiments of a system and a method of monitoring and responding to a gaming event are explained in conjunction with the description of FIGS. 1-7.

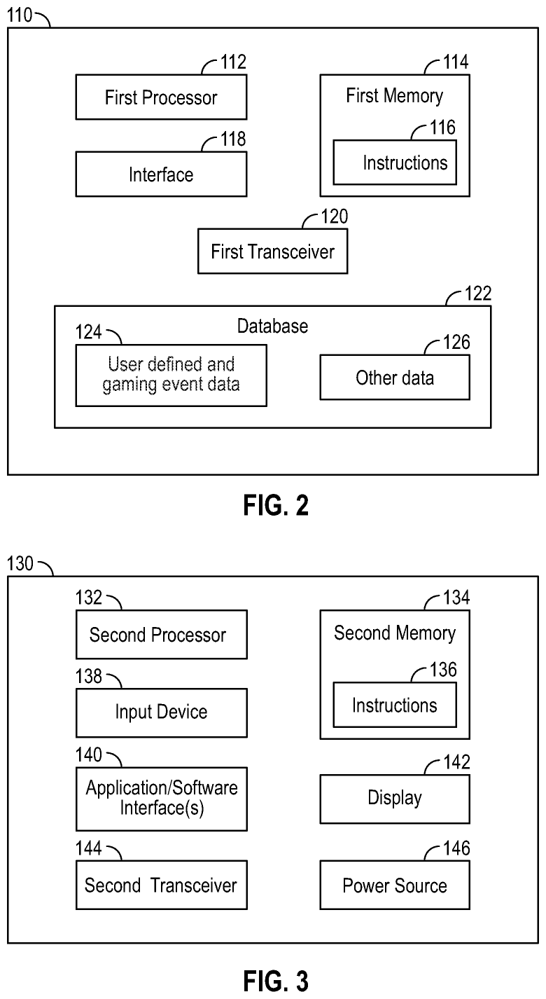

In one embodiment, the present invention discloses a system for monitoring and responding to a gaming event with an alert or a recommendation to end the session or event. FIG. 1 shows an environment 100 in which system 110 for alerting or recommending gamers to end a gaming session may be implemented, in accordance with one embodiment of the present invention. FIG. 2 shows a block diagram of system 110. System 110 may include first processor 112 (e.g., central processing unit (CPU), graphics processing unit (GPU) or both. System 110 may include first memory 114 which communicate with first processor 112 via bus (not shown).

First processor 112 may include any suitable processing device, such as a microprocessor, microcontroller, integrated circuit, logic device, or other suitable processing device.

First memory 114 may include one or more computer-readable media, including, but not limited to, non-transitory computer-readable media, RAM, ROM, hard drives, flash drives, or other memory devices. First memory 114 may store information accessible by first processor 112, including computer-readable instructions 116 that can be executed by first processor 112. In one example, first memory 114 may store data that can be retrieved, manipulated, created, or stored by first processor 112.

Instructions 116 may include any set of instructions that when executed by first processor 112, cause first processor 112 to perform operations. Instructions 116 may also reside, completely or at least partially, within first memory 114 and/or within first processor 112 during execution thereof by system 110, first memory 114 and first processor 112 also constituting machine-readable medium. Instructions 116 may further be transmitted or received over network 128 via first transceiver 120 utilizing any one of a number of well-known transfer protocols or a custom protocol.

System 110 may include user interface (UI) 118 i.e., software or Application interface allowing user of user device 130 or administrator or operator of gaming machine 150 to interact with system 110.

System 110 may include first transceiver 120 configured to send and receive data from system 110 to other devices such as user device 130 and gaming machine 150.

System 110 may include database 122. Database 122 indicates data structure configured for storing information. In the current embodiment, database 122 includes user defined and gaming event data 124, and any other (relevant) data 126. User defined and gaming event data 124 may include data corresponding to preferential game settings defined by user and details of gaming machine 150. For example, user defined and gaming event data 124 may include name, type of gaming events, level of gaming events, virtual coins, credits or currency available, weights (or importance levels) assigned for gaming event criteria, location, game duration, etc. from user device 130, and serial number, manufacturer, etc.

System 110 may communicatively connect to user devices 130 over network 128 (FIG. 1). Network 128 may include a short-range wireless network such as Bluetooth, ZigBee, Radio-frequency Identification (RFID), beacons, Near Field Communication (NFC) and so on. Alternatively, network 128 may include wireless network, wired network or combination thereof. Network 128 may be implemented as one of the different types of networks, such as intranet, local area network (LAN), wide area network (WAN), the internet, and the like. Network 128 may either be a dedicated network or shared network. Shared network represents an association of the different types of networks that use variety of protocols, for example, Hypertext Transfer Protocol (HTTP), Transmission Control Protocol/Internet Protocol (TCP/IP), Wireless Application Protocol (WAP), and the like, to communicate with one another.

User devices 130 may include first user device 130a, second user device 130b, third user device 130c, and so on, each of the user devices 130 configured for use by a different user or gamer. For ease of reference, first user device 130a, second user device 130b, third user device 130c may collectively referred as user device 130.

FIG. 3 shows a block diagram of user device 130. User device 130 may include mobile phone, laptop, desktop, tablet, smart watch and any other electronic device. User device 130 includes second processor 132 (e.g., central processing unit (CPU), graphics processing unit (GPU) or both. User device 130 includes second memory 134 which communicate with second processor 132 via bus (not shown).

Second processor 132 may include any suitable processing device, such as a microprocessor, microcontroller, integrated circuit, logic device, or other suitable processing device.

Second memory 134 may include one or more computer-readable media, including, but not limited to, non-transitory computer-readable media, RAM, ROM, hard drives, flash drives, or other memory devices. Second memory 134 may store information accessible by second processor 132, including computer-readable instructions 136 that can be executed by second processor 132. In one example, second memory 134 can be used to store data that can be retrieved, manipulated, created, or stored by second processor 132.

Instructions 136 can be any set of instructions that when executed by second processor 132, cause second processor 132 to perform operations. Instructions 136 may also reside, completely or at least partially, within second memory 134 and/or within second processor 132 during execution thereof by user device 130, second memory 134 and second processor 132 also constituting machine-readable medium. Instructions 136 may further be transmitted or received over network 128 via second transceiver 144 utilizing one of several of well-known transfer protocols or a custom protocol.

User device 130 may include input device 138. Input device 138 includes keyboard/keypad, or touch screen used for providing an input to user device 130.

User device 130 may include an Application or software interface 140 allowing user of user device 130 to interact with system 110 and gaming machine 150.

User device 130 may include (first) display 142 used for displaying data in the form of text/video to user of user device 130.

User device 130 may include second transceiver 144 configured to send and receive data from user device 130 to other devices such as system 110 and gaming machine 150.

User device 130 may include power source 146 such as a battery for powering various components of user device 130.

System 110 may further communicatively connect to gaming machine 150 via network 128 (FIG. 1). Gaming machine 150. Here, gaming machine 150 including a slot machine is shown for illustrative purpose only and should not be construed in limited sense. Other gaming machine for playing different games or gaming events may also be used in place of slot machine. For example, gaming machine 150 such as a table game machine, slot machine like those in a casino environment, video poker machine or any online game including non-machine gaming that may be played in a virtual environment may also be provided in addition to or in lieu of the slot machine, and such implementations come within the scope of the present invention.

FIG. 4 shows a block diagram of gaming machine 150.

Gaming machine 150 may include third processor 152, third memory 154 which communicate with third processor 152 via bus (not shown).

Gaming machine 150 may include input device 156 such as a keyboard/keypad, or touch screen used for providing an input to gaming machine 150.

Gaming machine 150 may include second display 158 used for displaying data in the form of text/video to user of gaming machine 150.

Gaming machine 150 may include game interface 160 allowing user to interact with gaming machine 150, and other devices such as system 110 and user device 130. Here, user/gamer may play the game by operating the physical or software buttons/toggles provided at gaming machine 150.

Gaming machine 150 may include start/stop button 162. Gaming machine 150 may include battery 164. Gaming machine 150 may include third transceiver 166 configured to send and receive data from gaming machine 150 to other devices such as system 110 and user device 130.

As specified above, system 110 may monitor or assess and recommend user/gamers to end a gaming session. In order to monitor and respond to users or players to terminate the gaming session, at first, system 110 may request a gamer to register user device 130 with system 110. As such, gamer may register with system 110 by providing relevant details such as name, gaming events subscribed, levels or stages completed in a gaming event, amount of coins, credits, currency (both virtual and physical) at hand, session roll-on, month roll-on or year roll-on of credits, amount of coins or credits or currency user wishes to wager in each level or gaming session, location, amount or willingness to take risky actions, stake in a particular game, gamer's future near-term obligations (social or financial), in-game user state of gamer and so on. In the description, the terms “gaming event” or “game” or “gaming session” are used interchangeably. Further, the terms “user”, “player” and “gamer” are used interchangeably. Here, game may include, an online game, a land-based game play, a game of chance, a game of skill or any other game.

After registering, system 110 may store details of user in first memory 114. Similarly, each user/gamer/player using respective user devices 130 may register with system 110. Further, system 110 may request user/operator of gaming machine 150 to register with system 110. As such, user of gaming machine may register with system 110 by providing relevant details.

In order to respond to gaming events with recommendations to gamers to have better experience of the gaming event and to minimize variance of losses while experiencing the gaming event, system 10 may allow gamer to determine game criteria for receiving recommendation or alert from system 110 to end the gaming session. In accordance with one embodiment, system 110 may allow the player to define the game criteria based on the player's perspective of the gaming event based on which the system 110 may provide a recommendation to end the gaming session.

For example, system 110 may allow the gamer/player to configure/define the game criteria as an “observed game experience”, a “game stake”, a “post-game element” and an “in-game user state”. The “observed game experience” may indicate player's observation of other players' (participants) willingness to make risky actions at the table or in the gaming event. Alternatively, the “observed game experience” may indicate player's observation of an ongoing promotion or bonus in the gaming event that may benefit the player during the gaming session.

The “game stake” may indicate player's stake in the game or funds that are currently in play and are at risk.

The “post-game element” may indicate players' future near-term obligations that may influence his play and time available for the gaming session.

The “in-game user state” may indicate players' state of mind that may influence his play during the gaming session.

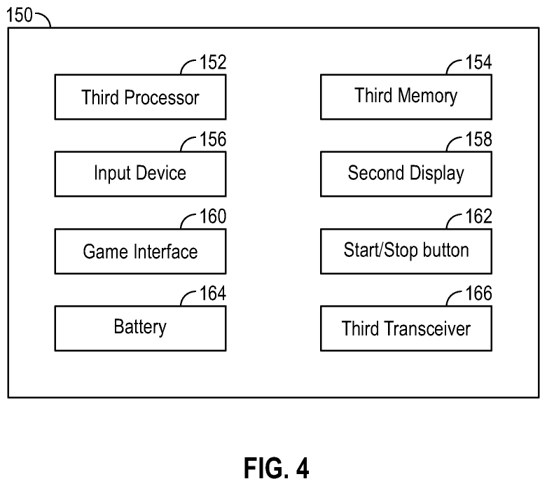

In one implementation, system 110 may allow the player to assign weights (importance levels) for each of the game criteria. For example, system 110 may allow player to use user device 130 to assign or determine weights for the “observed game experience” criteria. For instance, the player may assign weights 70% or 0.7 by selecting options provided at display 142. In one example, the player may select the weights determining a numerical value or using application software (graphical) interface 140 displaying a sliding bar as shown in FIG. 5. Similarly, the player may assign or determine weights for each of other game criteria i.e., “game experience stake”, “post-game element” and “in-game user state”.

In another embodiment, system 110 may allow the player to select his/her preferred choice of game criteria to experience the gaming session. Subsequently, system 110 may allow the player to use user device 130 to determine weights corresponding to the game criteria. For example, the player may select the “game experience stake” (FIG. 5) criteria. For the selected game criteria, the player may assign or determine the weights for “game experience stake” and other remaining game criteria i.e., “observed game experience”, “post-game element” and “in-game user state”. In the current example, the player may assign weights: 0.75 to “game experience stake”, 0.15 to “observed game experience”, 0.05 to “post-game element” and 0.05 to “in-game user state”. It should be understood that the above example is provided for illustration purpose only and should not be construed in a limited sense. For example, the player may determine weights based on criteria such as “hungry”, “tired”, etc. In addition, user may allow system 110 to determine recommendation based on his heartbeat, temperature and other health diagnostic information collected by the user device 130 to allow the system 110 to respond with recommendations to end the gaming session.

Similarly, if the player selects “post-game element” as his game criteria, then he/she may assign the weights for “post-game element” and other remaining game criteria. In the current example, the player may assign weights: 0.65 to “post-game element”, 0.20 to “game experience stake”, 0.10 to “observed game experience”, and 0.05 to “in-game user state”.

It should be understood that the player may assign different weights for each game criteria based on his/her perceived influence which he/she wishes the system 110 to provide a recommendation to end the player's gaming session. This way, the player may have better experience at playing or participating in the gaming event and get reminders or warnings or recommendations from system 110 when his/her chances of losing/diminishing game experience or losing coins, funds and other influencing factors are more. Further, if the player's experience improves while playing the game, then their inputs to system 110 will have a corresponding influence to potentially delay the end game recommendation to a later time.

Further, system 110 may allow the player to specify an importance level (weight) corresponding to each of game criteria. Based on the game criteria defined by the user, the system 110 may respond with an alert to user to end the gaming session. In another example, the system 110 may respond with a recommendation to terminate or cancel the gaming event. Here, when a recommendation values equals or exceeds the threshold value, then system 110 may respond with an alert or recommend the player on his/her user device 130 to terminate the gaming session. After assigning weights or important levels for each selected game criteria, the data is stored in second memory 134. Subsequently, the player may use user device 130 to transmit the data to system 110. System 110 receives the data and stores in first memory 114.

FIG. 5 shows an exemplary embodiment in which user selects game criteria on software interface 140 displayed on display 142. At first, user may select game 180 and corresponding game parameters 182. Here, the game parameters 180 indicate the game criteria for a particular game that the user has selected. For the selected game, user may adjust importance level 184 by adjusting values 186 for the game criteria 182. The user may start the game 190 which in turn starts the elapsed time clock 190 for the game 180. Here, the user enters importance level for elapsed time. The user enters value of money 188 and importance level corresponding to the money. The software interface 140 further includes an indicator 192 configured to provide visual display of the response provided by the system 110. The system 110 may prompt the user to respond with selecting an option 194 to end or terminate the gaming event. The user may also adjust settings and/or criteria and have the option to continue gaming.

In accordance with one embodiment of the present invention, system 110 may calculate a recommendation value based on parameters received from user on device 130. Specifically, system 110 may calculate the recommendation value based on user selected criteria and weights (or importance levels) that correspond to the user selected criteria, money at stake, and elapsed time. In one example, system 110 may calculate the recommendation value based on following equation:

$$R = \frac{100}{1 - {b}^{1 b - 2}} ( {b}^{wt} - 1 ) + 100$$

R indicates recommendation value; b indicates weights (importance levels) and normalized game criteria values; t indicates elapsed time; and w indicates importance weighting of elapsed time.

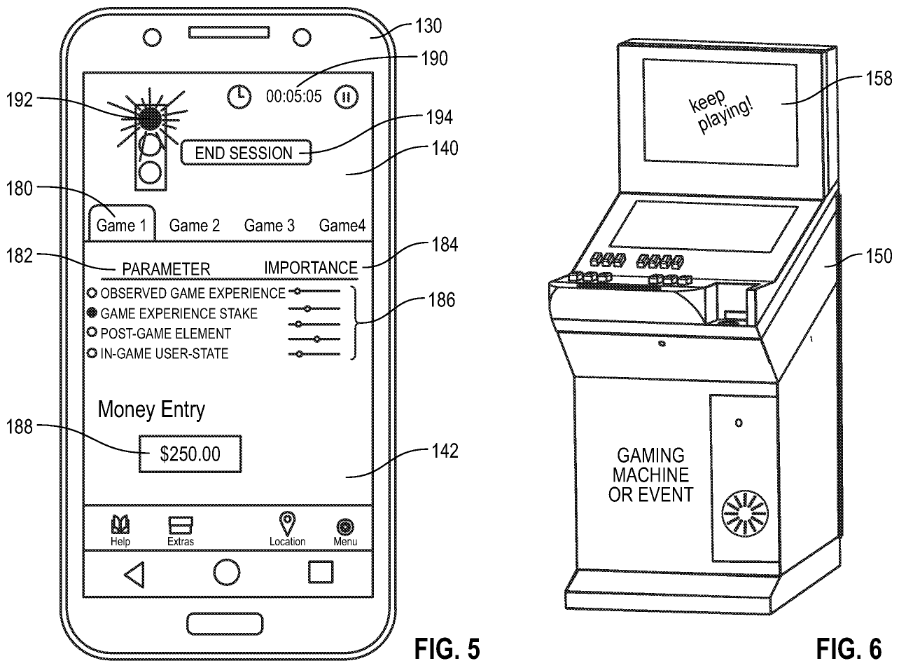

Considering the example shown in FIG. 5, system 110 receives an input when the player initiates playing/participating in a gaming event. Once initiated, system 110 begins calculating the recommendation value in real-time based on the game criteria, and associated weights or importance levels selected by the player. In one embodiment, system 110 may receive information from other players playing the game along with the player. When the recommendation value equals or exceeds the threshold values, then system 110 may respond by generating and transmitting an alert to user device 130. Specifically, first processor 112 continuously monitors or calculates or assesses the recommendation value. Once the recommendation value equals or exceeds the threshold value, the first processor 112 employs first transceiver 120 to transmit a signal to user device 130. Second transceiver 144 may receive the signal and send the signal to second processor 132. Second processor 132 may convert the signal and display an alert or recommendation on display 142, as shown in FIG. 5. In one example, the alert may include a text or audio or video message or notification. In another example, user device 130 may be configured to vibrate to signal to the player to end the gaming session. In another example, the alert may be transmitted to gaming device 150 where the player is playing the game, as shown in FIG. 6. As specified above, the system 110 responds with an alert or recommendation to help the player to end or terminate to minimize the player losing coins or credits. Alternatively, the alert acts as a warning sign or reminder notice for the player to recall the post-game obligations. The player may then quit or end or terminate the game.

The player may receive the alert and terminate the gaming session. Alternatively, the player may ignore the alert and continue to play the game after adjusting parameters. In one example, the player may postpone or reschedule the alert to appear after a five (5) minute hiatus. During the hiatus, system 110 may continuously calculate recommendation value, and respond with an alert and transmit further alert to the player on user device 130.

In one alternate embodiment, if the calculated recommendation value is below the threshold value, then system 110 may respond by generating an alert or recommendation to the player to terminate playing the game.

It should be understood that the player may modify the weights (importance levels) for one or all of game criteria based on need or as desired.

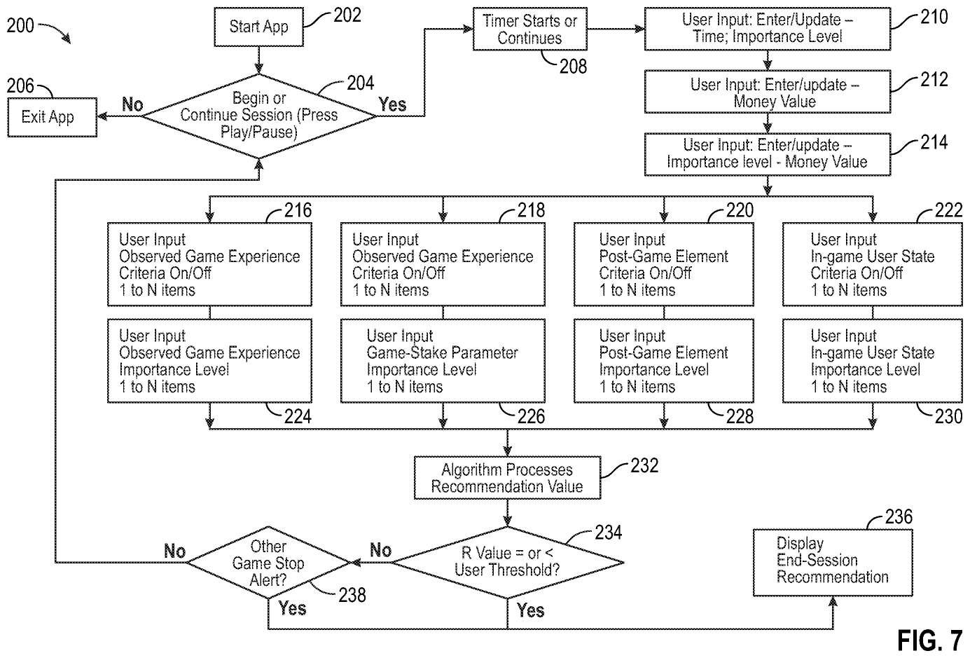

FIG. 7 shows a method 200 of monitoring and alerting or recommending gamers to end a gaming session is explained with illustrations, in accordance with one exemplary embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 may be implemented using the above-described system 110.

Method 200 starts at step 202. At step 202, the player may initiate an application on user device 130 or gaming machine 150 to play a game. At step 204, system 204 may check whether the player has started a new game or continuing an earlier/previous game. If system 110 determines that the gaming session has not started, then method 200 moves to step 206 and ends.

If system 110 determines that the gaming session has started at step 204, then method 200 moves to step 208.

At step 208, user 110 initiates the system to start a timer. At step 210, the player may input values corresponding to importance of time. Further, the player may input money or currency value, as shown at step 212. Further, the player may input importance level for the money or currency value that was input in step 212, as shown at step 214.

After entering the values, method 200 moves to steps 216, 218, 220 and 222. At step 216, system 110 checks if the player has turned ON or OFF the game criteria i.e., “observed game experience” to calculate the recommendation value. Person skilled in the art will understand that system 110 checks all the criteria selected by the user. If the player has turned ON the game criteria, then system 110 may utilize the corresponding user defined importance levels, as shown at step 224. Subsequently, method 200 moves to step 232.

At step 218, system 110 checks if the player has turned ON or OFF the game criteria i.e., “game stake” to calculate the recommendation value. If the player has turned ON the game criteria, then system 110 may utilize the corresponding user defined importance levels, as shown at step 226. Subsequently, method 200 moves to step 232.

At step 220, system 110 checks if the player has turned ON or OFF the game criteria i.e., “post-game element” to calculate the recommendation value. If the player has turned ON the game criteria, then system 110 may utilize the corresponding user defined importance levels, as shown at step 228. Subsequently, method 200 moves to step 232.

At step 222, system 110 checks if the player has turned ON or OFF the game criteria i.e., “in-game (user) state” to calculate the recommendation value. If the player has turned ON the game criteria, then system 110 may utilize the corresponding user defined importance levels, as shown at step 230. Subsequently, method 200 moves to step 232. Person skilled in the art will understand that steps 216 to 222 may occur in any order.

At step 232, system 110 may calculate recommendation value based on the game criteria selected by the player at one of the steps 216, 218, 220 and 222. After calculating the recommendation value, if the recommendation value equals or less than the threshold value (step 234), then system 110 responds by generating an alert or recommendation and displays on user device 130 or gaming device 150 to end the gaming session (step 236). If the recommendation value is more than the threshold value at step 234, then method 200 moves to step 238. At step 238, system 110 may generate another alert such as “continue playing” or any other recommendation. If the recommendation value equals or exceeds the threshold value anytime during execution of step 238, then method 200 moves to step 236 and displays a recommendation to end the gaming session (step 236). Else, the method 200 moves to step 204.

Based on the above, it is evident that system seeks to minimize variance of losses for players while experiencing gaming events. This way, the system ensures that players' get recommendations or alerts based on their perspective of the dynamic gaming event thereby enhancing the user experience for garners. The system monitors a user's game criteria and parameters then responds with a recommendation to stop or end their game to minimise risk from losing all their virtual or real coins, credits or currency.

Since the user/player defines weights (importance level) that correspond to the importance of the observed game experience, the game stakes, any post-game items, and user's in-game user state, the player is able to customize how the system should recommend rather than the system making decisions or recommending based on some other seemingly arbitrary criteria. The alert or recommendation helps the player to end or terminate to minimize losing more coins or credits. This may allow him or her to play the game longer and have a better experience.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. In addition, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the industry, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purpose only and should not be construed in limited sense. A person skilled in the art will appreciate alternate components that may be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants included in the scope of the invention.

What is claimed is:

1. A method of monitoring and responding to a dynamic gaming event, the method comprising:
receiving, by a processor, game criteria from a player corresponding to the player's perspective of continuing or terminating a gaming event;
receiving, by the processor, weights and an elapsed time for recommendation corresponding to the game criteria;
capturing, by the processor, initiation of the player playing the gaming event;
calculating, by the processor, a recommendation value based on the game criteria, the weights and the elapsed time; and
responding, by the processor, by generating a recommendation when the recommendation value equals or exceeds a threshold value, wherein the recommendation comprises an indication to the player to terminate the gaming event.

2. The method of claim 1, wherein the game criteria comprises one of an “observed game experience”, a “game stake”, a “post-game element” and an “in-game user state”,
wherein the “observed game experience” indicates player's observation of an ongoing promotion or bonus in the gaming event benefitting the player during the gaming event,
wherein the “game stake” indicates player's stake in the gaming event or funds that are currently in play and are at risk,
wherein the “post-game element” indicates players' future near-term obligations that influence the player's play and time available for the gaming event, and
wherein the “in-game user state” indicates players' state of mind influencing the player's gameplay during the gaming event.

3. The method of claim 1, further comprising transmitting, by the processor, the recommendation to a user device.

4. The method of claim 1, wherein the recommendation comprises an alert, wherein the alert comprises one of a text message, an audio alert, a video message and a notification.

5. The method of claim 3, further comprising displaying, by the user device, the recommendation to the player.

6. The method of claim 1, further comprising transmitting, by the processor, the recommendation to a gaming device.

7. The method of claim 6, further comprising displaying, by the gaming device, the recommendation to the player.

8. The method of claim 1, wherein the recommendation value is calculated based on an equation:
$$R = \frac{100}{1 - {b}^{1 b - 2}} ( {b}^{wt} - 1 ) + 100$$
wherein R indicates the recommendation value; b indicates the weights and normalized game criteria values; t indicates an elapsed time of the elapsed time; and w indicates importance weighting of the elapsed time.

9. The method of claim 1, further comprising generating, by the processor, a recommendation when the recommendation value is less than the threshold value, wherein the recommendation comprises an indication to the player to continue the gaming event.

10. A system for monitoring and responding to a dynamic gaming event, the system comprising:
a processor; and
a memory coupled to the processor, wherein the processor is configured to execute program instructions stored in the memory, to:
receive game criteria from a player corresponding to the player's perspective of continuing or terminating a gaming event;
receive an elapsed time and weights corresponding to the game criteria for recommendation;
capture initiation of the player playing the gaming event;
calculate a recommendation value based on the game criteria, the weights and the elapsed time; and
respond with a recommendation when the recommendation value equals or exceeds a threshold value, wherein the recommendation comprises an indication to the player to terminate the gaming event.

11. The system of claim 10, wherein the game criteria comprises one of an “observed game experience”, a “game stake”, a “post-game element” and an “in-game user state”,
wherein the “observed game experience” indicates player's observation of an ongoing promotion or bonus in the gaming event benefitting the player during the gaming event,
wherein the “game stake” indicates player's stake in the gaming event or funds that are currently in play and are at risk,
wherein the “post-game element” indicates players' future near-term obligations that influence the player's play and time available for the gaming event, and
wherein the “in-game user state” indicates players' state of mind influencing the player's play during the gaming event.

12. The system of claim 10, wherein the processor executes the program instructions to transmit the recommendation to a user device.

13. The system of claim 10, wherein the recommendation comprises an alert, wherein the alert comprises one of a text message, an audio alert, a video message and notification.

14. The system of claim 12, wherein the user device displays the recommendation to the player.

15. The system of claim 10, wherein the processor executes the program instructions to transmit the recommendation to a gaming device.

16. The system of claim 15, wherein the gaming device displays the recommendation to the player.

17. The system of claim 10, wherein the processor executes the program instructions to generate a recommendation when recommendation value is less than the threshold value, wherein the recommendation comprises an indication to the player to continue the gaming event.

18. A non-transitory machine-readable storage medium having instructions stored thereon which, when executed by a processor of a system, causes the system to perform operations comprising:
receiving game criteria from a player corresponding to the player's perspective of continuing or terminating a gaming event;
receiving an elapsed time and weights corresponding to the game criteria for providing recommendation;
capturing initiation of the player playing the gaming event;
calculating a recommendation value based on the game criteria, the weights and the elapsed time; and
responding with a recommendation or alert when the recommendation value equals or exceeds a threshold value, wherein the recommendation comprises an indication to the player to terminate the gaming event.
